(19) United States
(12) Patent Application Publication
(10) Pub. No.: US 2006/0280892 A1
(43) Pub. Date: Dec. 14, 2006

(54) Rubber membranes that are useful for roofing and related methods

(76) Inventors: James A. Davis, Westfield, IN (US); William F. Barham JR., Prescott, AR (US); Patricia Aguilar-Suarez, Concord, OH (US)

Correspondence Address: Jon D. Wood;Chief I.P. Counsel, Bridgestone Americas Holdings, Inc., 1200 Firestone Parkway, Akron, OH, 44317, US

(21) Appl. No.: 11/413,572

(22) Filed: Apr. 28, 2006

Related U.S. Application Data
(60) Provisional application No. 60/676,028, filed on Apr. 29, 2005.

(51) Int. Cl. B32B 33/00

(52) U.S. Cl. 428/40.1

(57) ABSTRACT

A rubber sheeting material including an elastomeric polymer such as EPDM, carbon black, clay, talc and an extender. The rubber sheeting material is suitable for roofing applications.

This application claims the benefit of U.S. Provisional Application No. 60/676,028, filed Apr. 29, 2005.

### FIELD OF THE INVENTION

The present invention relates generally to rubber sheeting material including EPDM membranes for roofing applications.

### BACKGROUND OF THE INVENTION

Ethylene-propylene-diene terpolymer (EPDM) is extensively used in a variety of applications. For example, it is particularly useful as a polymeric sheeting material, which, because of its excellent physical properties, flexibility, weathering resistance, low temperature properties and heat aging resistance, has gained acceptance as a roofing membrane for covering industrial and commercial roofs. These roofing membranes are typically applied to the roof surface in a vulcanized or cured state and serve as an effective barrier to prevent the penetration of moisture to the covered roof.

These roofing membranes are typically prepared by compounding the base polymer of EPDM with appropriate fillers, processing oils, and other desired ingredients such as plasticizers, antidegradants, adhesive-enhancing promoters, etc., in a suitable mixer, and calendering the resulting compound into the desired thickness. The roofing membrane may also be cured by vulcanizing the resultant sheet in the presence of one or more vulcanizing agents and/or compatible vulcanizing accelerators. Vulcanizing agents such as sulfur or sulfur-donating compounds such as mercaptans are typically used, although vulcanization and curing may be done using other agents or in the presence of other compounds.

Mineral fillers such as clay, talc, silicas, mica, calcium carbonate, and the like are typically added to a roofing membrane formulation to increase burn resistivity, as described in U.S. Pat. No. 5,468,550.

### SUMMARY OF THE INVENTION

One or more embodiments of the present invention provide a method for improving the calendarability of a cured elastomeric terpolymer-based composition into a sheet for roofing membrane, the method comprising providing a mixture comprising from about 70 to about 95 parts by weight carbon black per 100 parts by weight terpolymer, from about 78 to about 103 parts by weight clay per 100 parts by weight terpolymer, from about 12 to about 37 parts by weight talc per 100 parts by weight terpolymer, from about 55 to about 95 parts by weight extender per 100 parts by weight terpolymer, and calendaring said mixture into a sheet wherein said calendered sheet shows uniform release from calendar rolls, and has a smooth surface appearance.

One or more embodiments of the present invention further provides a roofing membrane, which includes a cured elastomeric terpolymer, from about 70 to about 95 parts by weight carbon black per 100 parts by weight terpolymer, from about 78 to about 103 parts by weight clay per 100 parts by weight terpolymer, from about 12 to about 37 parts by weight talc per 100 parts by weight terpolymer, and from about 55 to about 95 parts by weight extender per 100 parts by weight terpolymer.

### DETAILED DESCRIPTION OF ILLUSTRATIVE EMBODIMENTS

The present invention is directed toward polymeric membranes that include cured olefinic terpolymers, extender materials, and a blend of filler materials. The combination of these components, and in particular the blend of filler materials, has unexpectedly provided membranes that demonstrate an improved balance of properties. In one or more embodiments, the rubber formulations form which the membranes are prepared, demonstrate improved calanderability, and the resultant membranes demonstrate improved tensile strength.

The membranes of the present invention include one or more cured olefinic terpolymers, carbon black, one or more clays, at least one of a talc or a mica, and one or more extenders. Additionally, these membranes may include other constituents that are employed in rubber membranes or rubber compounds.

The elastomeric terpolymer includes mer units that derive from ethylene, α-olefin, and optionally diene monomer. Useful α-olefins include propylene. In one or more embodiments, the diene monomer may include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, 5-(2-methyl-2-butenyl)-2-norbornene, and mixtures thereof. Olefinic terpolymers and methods for their manufacture are known as disclosed at U.S. Pat. No. 3,280,082, which is incorporated herein by reference. For purposes of this specification, elastomeric terpolymers may simply be referred to as EPDM.

In one or more embodiments, the elastomeric terpolymer may include at least 62 weight percent, and in other embodiments at least 64 weight percent mer units deriving from ethylene; in these or other embodiments, the elastomeric terpolymer may include less than about 70 weight percent, and in other embodiments less than about 69 weight percent, mer units deriving from ethylene. In one or more embodiments, the elastomeric terpolymer may include at least 2 weight percent, in other embodiments at least 2.4 weight percent, mer units deriving from diene monomer; in these or other embodiments, the elastomeric terpolymer may include less than about 4 weight percent, and in other embodiments less than about 3.2 weight percent, mer units deriving from diene monomer. In one or more embodiments, the balance of the mer units derive from propylene or other α-olefins.

In one or more embodiments, useful elastomeric terpolymers may be characterized by a Mooney Viscosity (ML₁₊₄@125° C.) of about 35 to about 70, and in other embodiments from about 60 to about 70.

Useful elastomeric terpolymers include amorphous terpolymers and semi-crystalline terpolymers. Amorphous polymers are those having from 0 to about 2 weight percent crystallinity; semi-crystalline polymers are those having from about 2 to about 13 weight percent crystallinity.

Useful elastomeric terpolymers are commercially available. Examples include Keltan® 2326 (available from DSM Elastomers, Harleen, Netherlands), which has a Mooney Viscosity (ML₁₊₄@125° C.) of about 50, an ethylene to propylene ratio of 66/34, and about 2.5 weight percent of a third monomer (5-ethylidiene-2-norborene). Also suitable for the present invention is Royalene® 4611, which has a Mooney Viscosity (ML₁₊₄@125° C.) of about 65+/−5, an ethylene content of about 68 weight percent, and about 2.5 weight percent of a third monomer.

In one or more embodiments, the elastomeric terpolymers are cured or crosslinked. In one particular embodiment, the elastomeric terpolymers are cured or crosslinked in an autoclave in the presence of steam and pressure.

The elastomeric terpolymers can be cured by using numerous techniques such as those that employ sulfur cure systems, peroxide cure systems, and quinine-type cure systems. The sulfur cure systems may be employed in combination with vulcanizing accelerators. Useful accelerators include thioureas such as ethylene thiourea, N,N-dibutylthiourea, N,N-diethylthiourea and the like; thiuram monosulfides and disulfides such as tetramethylthiuram monosulfide (TMTMS), tetrabutylthiuram disulfide (TBTDS), tetramethylthiuram disulfide (TMTDS), tetraethylthiuram monosulfide (TETMS), dipentamethylenethiuram hexasulfide (DPTH) and the like; benzothiazole sulfenamides such as N-oxydiethylene-2-benzothiazole sulfenamide, N-cyclohexyl-2-benzothiazole sulfenamide, N,N-diisopropyl-2-benzothiazolesulfenamide, N-tert-butyl-2-benzothiazole sulfenamide (TBBS) (available as Delac® NS from Crompton Corporation, Middlebury, Conn.) and the like; other thiazole accelerators such as 2-mercaptobenzothiazole (MBT) 2-mercaptobenzothiazole, (MBTS) benothiazole disulfide (MBTS), N,N-diphenylguanadine, N,N-di-(2-methylphenyl)-guanadine, 2-mercaptobenzothiazole, 2-(morpholinodithio)benzothiazole disulfide, zinc 2-mercaptobenzothiazole and the like; dithiocarbamates such as tellurium diethyldithiocarbamate, copper dimethyldithiocarbamate, bismuth dimethyldithiocarbamate, cadmium diethyldithiocarbamate, lead dimethyldithiocarbamate, sodium butyldithiocarbamate zinc diethyldithiocarbamate, zinc dimethyldithiocarbamate, zinc dibutyldithiocarbamate (ZDBDC) and mixtures thereof. Sulfur donor-type accelerators may be used in place of elemental sulfur or in conjunction with elemental sulfur if desired. In one embodiment, the cure system is devoid of thiuram monosulfides and disulfides. Sulfur donor-type accelerators may be used in place of the elemental sulfur or in conjunction therewith.

Examples of suitable peroxides that can be used as curing agents or co-curing agents include alpha-cumyl hydroperoxide, methylethylketone peroxide, hydrogen peroxide, acetylacetone peroxide, t-butyl hydroperoxide, t-butyl peroxybenzoate, 2,5-bis(t-butyl peroxy)-2,5-dimethylhexene, lauryl peroxide, benzoyl peroxide, 2,4-dichlorobenzoyl peroxide, dibenzoyl peroxide, bis(p-monomethylene-benzoyl) peroxide, bis(p-nitrobenzoyl) peroxide, phenylacetyl peroxide, and mixtures thereof.

Examples of inorganic peroxides which can be used as co-curing agents with p-quinone dioxime include lead peroxide, zinc peroxide, barium peroxide, copper peroxide, potassium peroxide, silver peroxide, sodium peroxide, calcium peroxide, metallic peroxyborates, peroxychromates, peroxydicarbonates, peroxydiphosphates, peroxydisulfates, peroxygermanates, peroxymolybdates, peroxynitrates, magnesium peroxide, sodium pyrophosphate peroxide, and mixtures thereof.

Examples of polysulfide activators for the quinone-type co-curing agents include calcium polysulfide, sodium polysulfide, as well as organic polysulfides having the general formula R—(S)ₓ—R, wherein R is a hydrocarbon group and x is a number from 2-4. Examples of organic polysulfides are disclosed in U.S. Pat. No. 2,619,481, which is incorporated herein by reference.

Conventional radiation equipment and techniques can also be employed in the practice of this invention. Suitable ionizing crosslinking promoters that can be used include: liquid high-vinyl 1,2-polybutadiene resins containing 90 percent 1,2-vinyl content; Sartomer SR-206 (ethylene glycol dimethacrylate), Di-Cup R(dicumyl peroxide, about 98 percent active), and Pental A (pentaerythritol resin prepared from tall oil). These chemical additives are preferably compatible with the other ingredients in the composition, they may also function to reduce the dosage of ionizing radiation needed to obtain the desired level of crosslinking.

Sulfur and sulfur-containing cure systems may be used, and may also be used with an accelerator. Suitable amounts of sulfur can be readily determined by those skilled in the art. In one or more embodiments from about 0.25 to 3.0 parts by weight (pbw) sulfur per 100 parts by weight rubber (phr) may be used. The amount of accelerator can also be readily determined by those skilled in the art. In one or more embodiments, from about 1.5 to about 10 pbw accelerator phr may be used

In one or more embodiments, useful carbon blacks include those generally characterized by average industry-wide target values established in ASTM D-1765. Exemplary carbon blacks include GPF (General-Purpose Furnace), FEF (Fast Extrusion Furnace), and SRF (Semi-Reinforcing Furnace). One particular example of a carbon black is N650 GPF Black, which is a petroleum-derived reinforcing carbon black having an average particle size of about 60 nm and a specific gravity of about 1.8 g/cc. Another example is N330, which is a high abrasion furnace black having an average particle size about 30 nm, a maximum ash content of about 0.75%, and a specific gravity of about 1.8 g/cc.

Useful clays include hydrated aluminum silicates. In one or more embodiments, useful clays can be represented by the formula Al₂O₃SiO₂.XH₂O. Exemplary forms of clay include kaolinite, montmorillonite, atapulgite, illite, bentonite, halloysite, and mixtures thereof. In one embodiment, the clay is represented by the formula Al₂O₃SiO₂.3H₂O. In another embodiment, the clay is represented by the formula Al₂O₃SiO₂.2H₂O. In a preferred embodiment, the clay has a pH of about 7.0.

In one or more embodiments, various forms or grades of clays may be employed. Exemplary forms or grades of clay include air-floated clays, water-washed clays, calcined clays, and chemically modified (surface treated) clay. IN other embodiments, untreated clay may be used.

Air-floated clays include hard and soft clays. In one or more embodiments, hard clays include those characterized as having a lower median particle size distribution, and higher surface area than soft clays. In one or more embodiments, soft clays include those characterized by having a higher median particle size distribution and lower surface area than hard clays. Hard and soft clays are disclosed in U.S. Pat. Nos. 5,468,550, and 5,854,327, which are incorporated herein by reference.

In one embodiment, the air-floated clays used have a pH of from about 4.0 to about 8.0, and in another embodiment, the pH is about neutral. The airfloated clays have an average particle size of less than about 2 microns. Typical airfloated clays have a specific gravity of around 2.6 g/cc.

Airfloated clays, both hard and soft, are available through various sources. Available from Unimin Corporation (New Canaan, Conn.) is Snobrite™ AF, which is an airfloated hard clay having a pH of about 5.5 to 7.5, a median particle size of about 1 micron, and a specific gravity of about 2.6 g/cc. Available from Kentucky-Tennessee Clay Company (Mayfield, Ky.) is Paragon, which has a pH of about 4.5 to 5.5, a median particle size of about 1 micron, and a specific gravity of about 2.6 g/cc, and Tennessee Clay No. 6, an airfloated hard clay with a pH of from about 5.5 to 6.5, a median particle size of about 1.0 micron, and a specific gravity of about 2.6. A soft airfloated clay from Unimin Corporation (New Canaan, Conn.) is Hi White R®, which has a pH of about 6.25, a median particle size of less than about 1 micron, and a specific gravity of about 2.6 g/cc, Alumex, and Suprex, all airfloated soft clays. Available from J.M. Huber Corporation (Atlanta, Ga.) is Barden R, and LGB, which are both airfloated hard clays, and K-78, an airfloated soft clay. Available from R.T. Vanderbilt Company (Norwalk, Conn.) is McNamee Clay, which is an airfloated soft clay having a pH of about 5.0 to 7.5, a median particle size of about 1 micron and a specific gravity of about 2.6 g/cc.

Water washed clays include those clays that are more closely controlled for particle size by the water fractionation process. This process permits the production of clays within controlled particle size ranges. In one embodiment, the average particle size of the clay is less than about 2 microns in diameter. In another embodiment, the pH of the clay is about 7. Available from J. M. Huber Corporation (Atlanta, Ga.) are water washed clays such as Polyfil® DL, Polyfil® F, Polyfil® FB, Polyfil® HG-90, Polyfil® K and Polyfil® XB. In one embodiment, a water washed kaolin clay includes hydrated aluminum silicate and titanium dioxide, which has a pH of from about 6 to about 7.5, and a specific gravity of about 2.6 g/cc.

Calcined clays include those that result from the removal of water contained in clays (clays typically contain about 14 percent water) by calcinations. The amount of bound water removed determines the degree of calcinations. In one embodiment, the average particle size of the clay is less than about 2 microns in diameter. In another embodiment, the pH of the clay is about 7. Available from J.M. Huber Corporation (Atlanta, Ga.) are calcined clays such as Polyfil® 40, Polyfil® 70, and Polyfil® 80.

Chemically modified (surface treated) clays include those that have cross-linking ability, which can be imparted to the clay by modifying the surface of individual particles with a polyfunctional silane coupling agent. In one embodiment, the average particle size of the clay is less than about 2 microns in diameter. In another embodiment, the pH of the clay is about 7. Available from J.M. Huber Corporation (Atlanta, Ga.) are Nucap® 100 G, Nucap® 200, Nucap® 190, Nucap® 290, Nulok® 321, Nulok® 390, and Polyfil® 368.

Useful talc include hydrated magnesium silicate. In one or more embodiments, talc can be represented by the formulae Mg₃Si₄O₁₀(OH)₂ or 3MgO.4SiO₂.H₂O. Exemplary forms of talc include talcum, soapstone, steatite, cerolite, magnesium talc, steatite-massive, and mixtures thereof. Talc filler may contain various other minerals such as dolomite, chlorite, quartz, and the like. Talc used as filler may also exhibit characteristics such as hydrophobicity, organophilicity, non-polarity, and chemically inertness. In one embodiment, the talc has a specific gravity of from about 2.6 to about 2.8, a pH of from about 7.0 to 8.7, a refractive index of about 1.57 at 23° C., and a moisture content of less than about 0.5 weight percent. A representative talc is Talc 9107, which is available from Polar Minerals (Mt. Vernon, Ind.), which is non-abrasive, chemically inert, has a specific gravity of about 2.8, a pH of about 8.7, a refractive index of about 1.57 at 23° C., and a moisture content of less than about 0.3 weight percent.

Another suitable talc is Mistron® Vapor Talc, which is available from Luzenac America (Centennial, Colo.). Mistron® Vapor Talc is a soft, ultra-fine, white platy powder having a specific gravity of 2.75, a median particle size of 1.7 microns, an average surface area of 18 m²/g, and a bulk density (tapped) of 20 lbs/ft³. Other talc available from Luzenac America (Centennial, Colo.), includes Vertal MB, and Silverline 002. In one embodiment, talc is characterized as a platy, chemically inert filler having a specific gravity of from about 2.6 to about 2.8, a pH of about 7, and a moisture content of less than about 0.5 weight percent.

Useful extenders include paraffinic, naphthenic oils, and mixtures thereof. These oils may be halogenated as disclosed in U.S. Pat. No. 6,632,509, which is incorporated herein by reference. In one or more embodiments, useful oils are generally characterized by low surface content, low aromaticity, low volatility and a flash point of more than about 550° F. Useful extenders are commercially available. One particular extender is a paraffinic oil available under the tradename SUNPAR™ 2280 (Sun Oil Company). Another useful paraffinic process oil is Hyprene P150BS, available from Ergon Oil Inc. of Jackson, Miss.

In addition to the foregoing constituents, the membranes of this invention may also optionally include mica, coal filler, ground rubber, titanium dioxide, calcium carbonate, silica, homogenizing agents, phenolic resins, flame retardants, zinc oxide, stearic acid, and mixtures thereof. Certain embodiments may be substantially devoid of any of these constituents.

Mica includes mixtures of sodium and potassium aluminum silicate. Mica can be defined by the chemical formula αΔ₂₋₃(Ω)₄O₁₀(Σ)₂, where the α ion is potassium, sodium, barium, calcium, cesium, and/or ammonium, the Δ ion is aluminum, lithium, iron, zinc, chromium, vanadium, titanium, manganese, and/or magnesium, the Ω ion is silicon, aluminum, beryllium, boron, and/or iron (+3), and Σ is oxygen, fluorine, or hydroxide ion. Micas include true micas, brittle micas, and interlayer-deficient micas. True micas include a majority of singularly charged ions (e.g., potassium and sodium) in the α position. Brittle micas include a majority of doubly charged ions (e.g., calcium or barium) in the α position. Interlayer-deficient micas include fewer cations in the interlayer (the layer between the tetrahedral-octahedral-tetrahedral layers of the crystalline structure) than true or brittle micas.

Examples of true micas include aluminoceladonite (potassium aluminum magnesium iron silicate hydroxide), boromuscovite (potassium borosilicate hydroxide), celadonite (potassium iron magnesium silicate hydroxide), chromphyllite (potassium chromium aluminum silicate hydroxide fluoride), ferroaluminoceladonite (potassium aluminum iron magnesium silicate hydroxide), ferroceladonite (potassium iron magnesium silicate hydroxide), muscovite (potassium aluminum silicate hydroxide), nanpingite (cesium aluminum silicate hydroxide), paragonite (sodium aluminum silicate hydroxide), roscoelite (potassium vanadium aluminum silicate hydroxide), tobelite (ammonium aluminum silicate hydroxide), annite (potassium iron aluminum silicate hydroxide), aspidolite (sodium magnesium aluminum silicate hydroxide), biotite (potassium magnesium iron aluminum silicate hydroxide fluoride), eastonite (potassium magnesium aluminum silicate hydroxide), ephesite (sodium lithium aluminum silicate hydroxide), hendricksite (potassium zinc aluminum silicate hydroxide), lepidolite (potassium lithium aluminum silicate fluoride hydroxide), masutomilite (potassium lithium aluminum manganese silicate fluoride), montdorite (potassium iron manganese magnesium aluminum silicate fluoride), norrishite (potassium lithium manganese silicate), polylithionite (potassium lithium aluminum silicate fluoride), phlogopite (potassium magnesium aluminum silicate hydroxide), preiswerkite (sodium magnesium aluminum silicate hydroxide), siderophyllite (potassium iron aluminum silicate hydroxide), tainiolite (potassium lithium magnesium silicate fluoride), tetra-ferri-annite (potassium iron silicate hydroxide), tetra-ferriphlogopite (potassium magnesium iron silicate hydroxide), trilithionite (potassium lithium aluminum silicate fluoride), zinnwaldite (potassium lithium iron aluminum silicate fluoride hydroxide), and mixtures thereof.

Examples of brittle micas include chernykhite (barium vanadium aluminum silicate hydroxide), margarite (calcium aluminum silicate hydroxide), anadite (barium potassium iron magnesium aluminum silicate hydroxide), bityite (calcium lithium aluminum beryllium silicate hydroxide), clintonite (calcium magnesium aluminum silicate hydroxide), kinoshitalite (barium magnesium aluminum silicate hydroxide), and mixtures thereof.

Examples of interlayer deficient micas include brammallite (sodium aluminum silicate hydroxide), glauconite (potassium sodium iron aluminum magnesium silicate hydroxide), illite (potassium pluminum silicate hydroxide), wonesite (sodium magnesium aluminum silicate hydroxide), and mixtures thereof.

In one embodiment, mica is characterized as a platy, chemically inert filler having a specific gravity of from about 2.6 to about 2.7, a pH of about 7, and a moisture content of less than about 0.5 weight percent. Micas with a mean particle diameter of less than about 2 microns may be employed in one or more embodiments.

Coal filler includes ground coal. Ground coal may be characterized as a dry, finely dividing black powder derived from a low volatile bituminous coal. In one or more embodiments, ground coal is characterized by a particle size ranging from a 0.26 microns to a 2.55 microns with the average particle size of 0.69±0.46 microns as determined on 50 particles using Transmission Electron Spectroscopy. Ground coal may produce an aqueous slurry having a pH of about 7.0 when tested in accordance with ASTM D-1512. One particular ground coal is designated Austin Black®, which has a specific gravity of about 1.26±0.03, an ash content of about 5.0%, and a sulfur content of about 0.8%. Austin Black® is commercially available from Coal Fillers, Inc. of Bluefield, Va.

Ground rubber includes cryogenically ground rubber. Cryogenically ground rubbers include cryogenically ground EPDM, butyl, neoprene, and mixtures thereof. In one embodiments, cryogenically ground EPDM rubber includes a fine black rubbery powder having a specific gravity of about 1.17 and a particle size ranging from about 30 to about 300 microns with an average particle size ranging from about 50 to about 80 microns.

Useful titanium dioxides include both rutile and anatase form of titanium dioxide. One useful commercial product is TiPure® R-960 (DuPont), which is a fine, white powder having a specific gravity of 3.90.

Useful calcium carbonates include finely ground calcium carbonate. In one or more embodiments, the calcium carbonate may be characterized by a specific gravity of about 2.71. Commercially available forms are available from Harwick Chemical, J. M. Huber Corporation, Georgia Marble, Genstar Stone Products and Omya, Inc.

Useful forms of silica (silicon dioxide) include crystalline and amorphous silica. The crystalline form of silica includes quartz, tridymite and cristobalite. Amorphous silica may occur when the silicon and oxygen atoms are arranged in an irregular form as identified by X-ray diffraction. Commercially available forms are available from PPG Industries, Inc. (Monroeville, Pa.), Degussa Corporation (Parsippany, N.J.) and J.M. Huber Corporation (Atlanta, Ga.).

Useful homogenizing agents include those composed of a mixture of dark brown aromatic hydrocarbon resins having a specific gravity of about 1.06 g/cc at 23° C. One particularly suitable homogenizing agent is available in flake or pastille form from Struktol Company under the tradename Struktol® 40 MS.

Useful phenolic resins include those that provide tack and green strength as well as improved long-term aging properties to the rubber composition. One phenolic resin is XR-14652A3, which has a specific gravity of 1.025 g/cc at 23° C., and is commercially availably from Sovereign Chemical Company.

Alumina trihydrates include finely divided, odorless, crystalline, white powders having the chemical formula Al₂O₃.3H₂O. Alumina Trihydrate can be utilized in the present invention to enhance the green strength of the base polymer. Useful alumina trihydrates have an average particle size ranging from about 0.1 micron to about 5 microns, and more preferably, from about 0.5 micron to about 2.5 microns.

In one embodiment, alumina trihydrate is characterized by a specific gravity of about 2.42 and an ash content of about 64-65 weight percent. Alumina trihydrate is commercially available from Franklin Industrial Materials, of Dalton, Ga. Notably, alumina trihydrate can also be advantageously used separately as a flame retardant and smoke suppressant in the EPDM-based roofing membrane composition of the present invention.

Other sources of alumina trihydrate are available from J. M. Huber Corporation of Norcross, Ga. under the trademark Micral®. These alumina trihydrates have a median particle size of about 1.1 microns to about 1.5 microns, a specific gravity of about 2.42, an ash content of about 64-65 weight percent and a loss on ignition at 1000° F. of about 34.65 percent by weight.

Still another useful non-combustible mineral filler suitable for the present invention is the ore of calcium borate. This filler is available in various particle size grades from American Borate Company, Virginia Beach, Va., under the tradename Colemanite® and has the chemical formula Ca₂B₆O₁₁.5H₂O. Colemanite® has a specific gravity of about 2.4. Colemanite® may have an average particle size of about 0.1 to about 5 microns, or from about 0.5 to about 2.5 microns.

Yet another flame-retardant mineral filler which may be particularly suitable for use in the roofing membrane of the present invention is magnesium hydroxide. Useful magnesium hydroxides (Mg(OH)₂) include finely divided, white powders that are extremely effective smoke suppressants as well as a flame-retardant additives.

In one or more embodiments, the polymeric membranes of this invention include from about 27 to about 50, in other embodiments from about 33 to about 45, and in other embodiments from about 37 to about 40% by weight elastomeric terpolymer based on the entire weight of the membrane.

In one or more embodiments, the polymeric membranes of this invention include from about 70 to about 100, in other embodiments from about 75 to about 90, and in other embodiments from about 77 to about 85 parts by weight carbon black per 100 parts by weight elastomeric terpolymer (i.e., rubber).

In one or more embodiments, the polymeric membranes of this invention include from about 78 to about 103, in other embodiments from about 85 to about 100, and in other embodiments from about 87 to about 98 parts by weight clay per 100 parts by weight elastomeric terpolymer.

In one or more embodiments, the polymeric membranes of this invention include from about 12 to about 37, in other embodiments from about 15 to about 28, and in other embodiments from about 18 to about 25 parts by weight talc per 100 parts by weight elastomeric terpolymer.

In one or more embodiments, the polymeric membranes of this invention include from about 55 to about 95, in other embodiments from about 60 to about 85, and in other embodiments from about 65 to about 80 parts by weight extender per 100 parts by weight elastomeric terpolymer.

In one or more embodiments, the membranes of this invention includes from about 12 to about 25 pbw mica phr. In other embodiments, the membrane includes less than 12 pbw mica phr, and in other embodiments less than 6 pbw mica phr. In certain embodiments, the membrane is devoid of mica.

In one or more embodiments, the polymeric membranes of this invention include less than about 10 pbw, in other embodiments less than 5 pbw, and in other embodiment less than 1 pbw coal filler phr. In one embodiment, the membrane is devoid of coal filler.

In one or more embodiments, the polymeric membranes of this invention include from about 5 to about 40 pbw ground rubber phr. In other embodiments, the membranes include less than 20 pbw, and in other embodiment less than 10 pbw ground rubber phr.

In one or more embodiments, the membranes of this invention includes from about 5 to about 40 pbw titanium dioxide phr. In other embodiments, the membrane includes less than 20 pbw titanium dioxide phr, and in other embodiments less than 10 pbw titanium dioxide phr. In certain embodiments, the membrane is devoid of titanium dioxide.

In one or more embodiments, the membranes of this invention includes from about 20 to about 300 pbw calcium carbonate phr. In other embodiments, the membrane includes less than 20 pbw calcium carbonate phr, and in other embodiments less than 10 pbw calcium carbonate phr. In certain embodiments, the membrane is devoid of calcium carbonate.

In one or more embodiments, the membranes of this invention includes from about 10 to about 100 pbw silica phr. In other embodiments, the membrane includes less than 10 pbw silica phr, and in other embodiments less than 5 pbw silica phr. In certain embodiments, the membrane is devoid of silica.

In one or more embodiments, the membranes of this invention includes from about 2 to about 10 pbw homogenizing agent phr. In other embodiments, the membrane includes less than 5 pbw homogenizing agent phr, and in other embodiments less than 3 pbw homogenizing agent phr. In certain embodiments, the membrane is devoid of homogenizing agent.

In one or more embodiments, the membranes of this invention includes from about 2 to about 10 pbw phenolic resin phr. In other embodiments, the membrane includes less than 4 pbw phenolic resin phr, and in other embodiments less than 2.5 pbw phenolic resin phr. In certain embodiments, the membrane is devoid of phenolic resin.

In one or more embodiments, the membranes of this invention includes from about 10 to about 65 pbw of a flame retardant package phr. In other embodiments, the membrane includes less than 10 pbw of a flame retardant package phr, and in other embodiments less than 5 pbw of a flame retardant package phr. In certain embodiments, the membrane is devoid of flame retardant.

The roofing membrane of the present invention can be prepared by conventional means using conventional rubber compounding equipment such as Brabender, Banbury, Sigma-blade mixer, two-roll mill, or other mixers suitable for forming viscous, relatively uniform admixtures. Mixing techniques depend on a variety of factors such as the specific types of polymers used, and the fillers, processing oils, waxes and other ingredients used. In one or more embodiments, the ingredients can be added together in a single shot. In other embodiments, some of the ingredients such as fillers, oils, etc. can first be loaded followed by the polymer. In other embodiments, a more conventional manner can be employed where the polymer added first followed by the other ingredients.

Mixing cycles generally range from about 2 to 6 minutes. In certain embodiments an incremental procedure can be used whereby the base polymer and part of the fillers are added first with little or no process oil, the remaining fillers and process oil are added in additional increments. In other embodiments, part of the EPDM can be added on top of the fillers, plasticizers, etc. This procedure can be further modified by withholding part of the process oil, and then adding it later. In one or more embodiments, two-stage mixing can be employed.

The sulfur cure package (sulfur/accelerator) can be added near the end of the mixing cycle and at lower temperatures to prevent premature crosslinking of the EPDM polymer chains. When utilizing a type B Banbury internal mixer, the dry or powdery materials such as the carbon black and non-black mineral fillers (i.e., untreated clay, treated clays, talc, mica, and the like) can be added first, followed by the liquid process oil and finally the polymer (this type of mixing can be referred to as an upside-down mixing technique).

Once mixed, the rubber composition can then be formed into a sheet via calendering. The compositions of the invention can also be formed into various types of articles using other techniques such as extrusion.

The resultant rubbery compositions may be prepared in sheet form in any known manner such as by calendering or extrusion. The sheet may also be cut to a desired dimension. In one or more embodiments, the resulting admixture can be sheeted to thicknesses ranging from 5 to 200 mils, in other embodiments from 35 to 90 mils, by using conventional sheeting methods, for example, milling, calendering or extrusion. In one or more embodiments, the admixture is sheeted to at least 40 mils (0.040-inches), which is the minimum thickness specified in manufacturing standards established by the Roofing Council of the Rubber Manufacturers Association (RMA) for non-reinforced EPDM rubber sheets for use in roofing applications. In other embodiments, the admixture is sheeted to a thickness of about 45 mils, which is the thickness for a large percentage of “single-ply” roofing membranes used commercially. The sheeting can be visually inspected and cut to the desired length and width dimensions after curing.

The calendered sheeting itself should show good, uniform release from the upper and lower calendar rolls and have a smooth surface appearance (substantially free of bubbles, voids, fish eyes, tear drops, etc.). It should also have uniform release from the suction (vacuum) caps at the splicing table and uniform surface dusting at the dust box.

The membranes of the present invention can be optionally reinforced with scrim. In other embodiments, the membranes are devoid of scrim.

The roof sheeting membranes can be evaluated for physical properties using test methods developed for mechanical rubber goods. Typical properties include, among others, tensile strength, modulus, ultimate elongation, tear resistance, ozone resistance, water absorption, burn resistivity, and cured compound hardness.

The membranes of this invention can be used as follows. As the sheet is unrolled over the roof substructure in a conventional fashion, the seams of adjacent sheet layers are overlapped. The width of the seam can vary depending on the requirements specified by the architect, building contractor, or roofing contractor and thus, do not constitute a limitation of the present invention. Seams can be joined with conventional adhesives such as, for instance, a butyl-based lap splice adhesive, which is commercially available from Firestone Building Products Company as SA-1065. Application can be facilitated by spray, brush, swab or other means known in the art.

Also, field seams can be formed by using tape and companion primer such as QuickSeam™ tape and Quick Prime Plus primer, both of which are commercially available from Firestone Building Products Company of Carmel, Ind.

In order to demonstrate the practice of the present invention, the following examples have been prepared and tested. The examples should not, however, be viewed as limiting the scope of the invention. The claims will serve to define the invention.

### EXAMPLES

The following examples are submitted for the purpose of further illustrating the nature of the present invention and are not to be considered as a limitation on the scope thereof. Parts of each ingredient are by weight, unless otherwise specified.

Several roofing membrane compounds were prepared according to the examples in Table I. the compounds were prepared by the compounding of the elastomers, fillers, processing materials, and other additives in a Brabender internal mixer, and resheeted to the desired dimensions using a 180° F. two-roll laboratory mill (calendered) as described hereinabove.

| | Compound Nos. | | | | | | |
|---|---|---|---|---|---|---|---|
| | 1 | 2 | 3 | 4 | 5 | 6 | 7 |
| Royalene ® 4611 | 100 | 100 | 100 | 100 | 100 | 100 | 100 |
| N650 HiStr GPF Black | 70.88 | 78 | 78 | 78 | 78 | 78 | 78 |
| N330 HAF Black | 26.12 | — | — | — | — | — | — |
| Coal Filler | 18.47 | — | — | — | — | — | — |
| Sunpar ® 2280 | | | | | | | |
| Process Oil | 76 | 67.5 | 67.5 | 67.5 | 67.5 | 67.5 | 67.5 |
| Mistron ® Vapor Talc | — | 18.5 | 18.5 | 18.5 | — | — | — |
| Snobrite ™ AF Clay | 51.07 | — | — | — | 90 | 90 | 90 |
| Paragon Clay | — | 90 | — | — | — | — | — |
| Suprex Clay | — | — | 90 | — | — | — | — |
| Tennessee Clay No. 6 | — | — | — | 90 | — | — | — |
| Talc 9107 | — | — | — | — | 18.5 | — | — |
| Vertal MB (talc) | — | — | — | — | — | 18.5 | — |
| Silverline 002 (talc) | — | — | — | — | — | — | 18.5 |
| Zinc Oxide | 3 | 2.5 | 2.5 | 2.5 | 2.5 | 2.5 | 2.5 |
| Stearic Acid | 1.82 | 2.25 | 2.25 | 2.25 | 2.25 | 2.25 | 2.25 |
| Sulfur | 1.05 | 1 | 1 | 1 | 1 | 1 | 1 |
| TBBS | 2.9 | 2.8 | 2.8 | 2.8 | 2.8 | 2.8 | 2.8 |
| TMTDS | 0.4 | 0.4 | 0.4 | 0.4 | 0.4 | 0.4 | 0.4 |
| TOTAL | 351.71 | 362.95 | 362.95 | 362.95 | 362.95 | 362.95 | 362.95 |
| Mooney Scorch at | | | | | | | |
| 135° C. - large rotor | | | | | | | |
| Minimum Viscosity | 41.6 | 37.8 | 42.5 | 42.4 | 39.9 | 39.4 | 40.8 |

The results of the various physical properties tested, including die c tear properties and stress-strain properties, are reported in Table II.

| | Compound Nos. | | | | | | |
|---|---|---|---|---|---|---|---|
| | 1 | 2 | 3 | 4 | 5 | 6 | 7 |
| Stress-Strain | | | | | | | |
| Properties at 73° F. | | | | | | | |
| 100% Modulus, psi | 415 | 413 | 421 | 427 | 423 | 406 | 419 |
| 300% Modulus, psi | 1012 | 1076 | 1039 | 1107 | 1060 | 1035 | 1045 |
| Tensile at break, psi | 1380 | 1712 | 1720 | 1545 | 1755 | 1635 | 1662 |
| Elongation at break, % | 445 | 490 | 524 | 438 | 516 | 480 | 501 |
| Die C Tear properties | 193 | 184 | 188 | 183 | 177 | 169 | 171 |
| at 73° F., Lbs./inch | | | | | | | |
| Low Strain Modulus at | 76 | 74 | 79 | 80 | 84 | 81 | 80 |
| 73° F., 25% Ext., psi | | | | | | | |
| Shore “A” Hardness | 67 | 67 | 68 | 67 | 67 | 67 | 68 |
| at 73° F. | | | | | | | |

For testing purposes, dumbbell-shaped specimens were cut using the appropriate metal die from individual cured 45 mil six by six-inch flat rubber slabs (compression molded 45 minutes at 160° C.) in accordance with ASTM D 412 (Method A—dumbbell and straight). Modulus, tensile strength and elongation at break measurements were obtained on both unaged and heat aged (28 days at 116° C.) dumbbell-shaped test specimens using a table model Instron™ Tester, Model 4301, and the test results were calculated in accordance with ASTM D 412. All dumbbell-shaped specimens were allowed to set for about 24 hours, before testing was carried out at 23° C. The Instron™ Tester (a testing machine of the constant rate-of-jaw separation type) is equipped with suitable grips capable of clamping the test specimens without slippage.

Tear properties were determined by using a metal die (90° angle die C) to remove the test specimens from cured 45 mil six by six-inch flat rubber slabs (compression molded 45 minutes at 160° C.) in accordance with ASTM D 624. All die C tear specimens were allowed to set for about 24 hours, before testing was carried out at 23° C.

Shore “A” hardness, which measures the hardness of the cured roofing membrane compound, was conducted at 23° C. in accordance with ASTM Method D 2240. The cured test specimens were allowed to set for about 24 hours prior to testing.

As a result of the production of sheeting to be made into the roofing membranes of the present invention that includes untreated clay and talc, unaged tensile strength can be increased over sheeting for roofing membranes that do not include this combination of clay and talc. In one embodiment, unaged tensile strength was increased from about 1,380 psi to as high as 1,676 psi using 90 phr untreated clay and 18.5 phr Mistron vapor talc.

Similarly, the green strength, predicted using the Low Modulus Strain test, has been shown to be increased when using a similar blend of untreated clay and talc in the sheeting composition. In one embodiment, green strength was increased from about 75 psi to about 100-110 psi.

It has been found that by using improved combinations, blends, or mixtures of untreated clay and talc, the calendarability of the formulation, as well as the tensile strength and green strength of the elastomeric sheeting can be improved or enhanced, compared to other elastomeric sheeting not having this blend or mixture or combination of untreated clay and talc.

Thus it should be evident that the sheeting material and method of the present invention are highly effective in covering the roof of a building. The invention is particularly suited for use on roofs of buildings, but is not necessarily limited thereto. The sheeting material of the present invention can be used separately with other equipment, methods and the like, such as, for example, for linings for fish ponds, decorative and aquatic gardens, ponds on golf courses, and the like.

Various modifications and alterations that do not depart from the scope and spirit of this invention will become apparent to those skilled in the art. This invention is not to be duly limited to the illustrative embodiments set forth herein.

What is claimed is:

1. A method for improving the calendarability of a cured elastomeric terpolymer-based composition into a sheet for roofing membrane, the method comprising:
providing a mixture comprising:
from about 70 to about 95 parts by weight carbon black per 100 parts by weight terpolymer;
from about 78 to about 103 parts by weight clay per 100 parts by weight terpolymer;
from about 12 to about 37 parts by weight talc per 100 parts by weight terpolymer;
from about 55 to about 95 parts by weight extender per 100 parts by weight terpolymer; and
calendaring said mixture into a sheet wherein said calendered sheet shows uniform release from calendar rolls, and has a smooth surface appearance.

2. The method of claim 1, where the mixture includes from about 27 to about 50 percent by weight elastomeric terpolymer based upon the entire weight of the mixture.

3. The method of claim 1, where the membrane includes from about 75 to about 85 parts by weight carbon black per 100 parts by weight terpolymer, from about 85 to about 95 parts by weight clay per 100 parts by weight terpolymer, from about 15 to about 37 parts by weight talc per 100 parts by weight terpolymer, and from about 65 to about 85 parts by weight extender per 100 parts by weight terpolymer.

4. The roofing membrane of claim 1, where the mixture includes less than 10 parts by weight coal filler per 100 parts by weight terpolymer.

5. The method of claim 1, where the mixture includes less than 10 parts by weight ground rubber per 100 parts by weight terpolymer.

6. The method of claim 1, where the mixture includes less than 10 parts by weight titanium dioxide per 100 parts by weight terpolymer.

7. The method of claim 1, where the mixture includes less than 10 parts by weight calcium carbonate per 100 parts by weight terpolymer.

8. The method of claim 1, where the mixture includes less than 10 parts by weight silica per 100 parts by weight terpolymer.

9. The method of claim 1, where the mixture includes less than 5 parts by weight homogenizing agent per 100 parts by weight terpolymer.

10. The method of claim 1, where the mixture includes less than 2.5 parts by weight phenolic resin per 100 parts by weight terpolymer.

11. The method of claim 1, where the mixture includes less than 10 parts by weight flame retardant per 100 parts by weight terpolymer.

12. The roofing membrane of claim 1, where the mixture includes less than 10 parts by weight mica per 100 parts by weight terpolymer.

13. The method of claim 1, where said clay includes hydrated aluminum silicates.

14. The method of claim 1, where said clay includes kaolinite, montmorillonite, atapulgite, illite, bentonite, halloysite, or mixtures thereof.

15. The method of claim 1, where said clay includes untreated clays.

16. The method of claim 1, where said talc includes hydrated magnesium silicate.

17. The method of claim 1, where said talc includes talcum, soapstone, steatite, cerolite, magnesium talc, steatite-massive, and mixtures thereof.

18. The method of claim 1, where said talc comprises a specific gravity of from about 2.6 to about 2.8, a pH of from about 7.0 to about 8.7, a refractive index of about 1.57 at 23° C. and a moisture content of less than about 0.5 weight percent.

19. The method of claim 1, where said extender includes a paraffinic oil, a naphthenic oil, or a mixture thereof.

20. A roofing membrane comprising:
a cured elastomeric terpolymer;
from about 70 to about 95 parts by weight carbon black per 100 parts by weight terpolymer;
from about 78 to about 103 parts by weight clay per 100 parts by weight terpolymer;
from about 12 to about 37 parts by weight talc per 100 parts by weight terpolymer; and
from about 55 to about 95 parts by weight extender per 100 parts by weight terpolymer.
